(19) United States
(12) Patent Application Publication
(10) Pub. No.: US 2005/0279085 A1
(43) Pub. Date: Dec. 22, 2005

(54) Energy conversion system

(76) Inventors: George V. Moore, Corona, CA (US); Clyde Collins, Gardena, CA (US)

Correspondence Address: Scot A. Reader, Esq., Suite 228, 1320 Pearl Street, Boulder, CO, 80302, US

(21) Appl. No.: 11/120,083

(22) Filed: May 2, 2005

Related U.S. Application Data
(60) Provisional application No. 60/580,892, filed on Jun. 18, 2004.

(51) Int. Cl. F16D 31/02

(52) U.S. Cl. 60/398

(57) ABSTRACT

Methods and systems for indirectly converting energy from the wave motion of water into electrical energy. The methods and systems use energy in water waves to pump fluid to an elevated water supply tank. The fluid is then released and flows by gravity to a fluid turbine/generator unit at a lower elevation, causing the turbine to spin and thereby drive the generator to produce electricity. Upon departing the water turbine/generator unit, the water is returned to, and feeds into, a water supply tank at a lower level. In one embodiment, the methods and systems use a pivot-type water pumping unit to capture and convert the energy of water waves. In another embodiment, the methods and systems use a slider-type water pumping unit to capture and convert the energy of water waves.

### CROSS-REFERENCE OF RELATED APPLICATION

This application claims the benefit of U.S. provisional Application No. 60/580,892, filed on Jun. 18, 2004, the contents of which are incorporated herein by reference.

### BACKGROUND OF THE INVENTION

Prior energy conversion systems that convert energy that exists in nature to electrical energy, such as windmills that drive electrical generators and solar panels that convert radiant solar energy from the Sun to electrical energy, have several limitations. Such limitations include limited energy availability over time. For example, a windmill can only convert wind energy to electrical energy when the wind is blowing, and the times, places, and amount of energy available at any given moment is unpredictable at best and nonexistent at worst. In addition, large numbers of windmills are needed to produce significant amounts of energy due to the very low density of air.

Solar energy is only available when the Sun is shining during daylight hours and can be limited by cloud formations and other atmospheric conditions. In addition, solar cells and solar panels usually require large surface areas due to their relatively low efficiency and the low density of radiant energy from the Sun. That is, the radiant energy per unit of surface area available is limited. As in the case of windmills, solar energy is only available for conversion to electrical energy during unpredictable times and at unpredictable locations. Said more precisely, solar energy is available only when the Sun is shining in the location where the solar panels are located and only during daylight hours.

Another energy source that exists in nature is tidal energy caused by the gravitational pull of the Moon. Tidal energy is available twenty-four hours a day seven days a week and every day of every year. The location of tidal energy is well known. It is at the shore lines of every ocean, sea, large lake and other large body of water. Water wave motion associated with tidal energy is always occurring and available at these locations. Moreover, due to the relatively high density of water, the amount of available energy is significantly higher than that from wind or solar energy. However, shoreline conditions have presented a significant obstacle to creating a practical energy conversion system that can harness tidal energy and convert it directly to electricity. Electricity generating equipment positioned at the shoreline is highly susceptible to corrosion and malfunction and can degrade the natural environment.

### SUMMARY OF THE INVENTION

The energy conversion methods and systems of the present invention overcome limitations of prior energy conversion systems that convert energy occurring in nature to electrical energy. The present methods and systems indirectly convert tidal energy that exists in nature in the form of water wave motion in oceans and other large bodies of water, such as large lakes, into electrical energy and electrical power. More particularly, the present methods and systems use a pumping unit to capture energy in water waves and pump fluid up a pipeline to an elevated fluid storage facility. The fluid in the elevated storage facility is then released and flows by gravity down a pipeline and is delivered to a fluid-driven turbine/generator unit at a lower elevation, causing the turbine to spin and thereby drive the generator to produce electricity. Upon departing the fluid-driven turbine/generator unit, the fluid is returned to, and feeds into, a fluid storage facility at a lower level. Fluid is then pumped from this lower storage facility back up to the elevated storage facility by the pumping unit, driven by the motion of the water waves. Because the water wave motion is not directly converted to electricity, but is instead converted to potential energy in the form of elevated fluid that is thereafter converted to electricity, the turbine/generator unit can be advantageously positioned remote from the shoreline, that is, can be land-based.

In one embodiment, the present methods and systems use a pivot-type pumping unit to capture and convert the energy of water waves. These methods and systems use a pivoting paddle as a wave-receiving substrate. In another embodiment, the present methods and systems use a slider-type pumping unit to capture and convert the energy of water waves. These methods and systems use a sliding plate as a wave-receiving substrate.

The present invention will be better understood by reference to the detailed description of the preferred embodiment taken in conjunction with the drawings briefly described below. Of course, the invention is defined by the appended claims.

### BRIEF DESCRIPTION OF THE DRAWINGS

FIG. 1 is a block diagram of an energy conversion system in a preferred embodiment of the invention.

FIG. 2 is an isometric view of a pivot-type pumping unit in a preferred embodiment of the invention.

FIG. 3 is a side cross-sectional view of a pivot-type pumping unit in a preferred embodiment of the invention.

FIG. 4 is a top view of a pivot-type pumping unit in a preferred embodiment of the invention.

FIG. 5 is an isometric view of a slider-type pumping unit in another preferred embodiment of the invention.

FIG. 6 is a side cross-sectional view of a slider-type pumping unit in another preferred embodiment of the invention.

FIG. 7 is a top view of a slider-type pumping unit in another preferred embodiment of the invention.

FIG. 8 is an isometric view of an energy conversion system utilizing a pivot-type pumping unit in a preferred embodiment of the invention.

FIG. 9 is an isometric view of an energy conversion system utilizing a slider-type pumping unit in another preferred embodiment of the invention.

### DETAILED DESCRIPTION OF THE PREFERRED EMBODIMENT

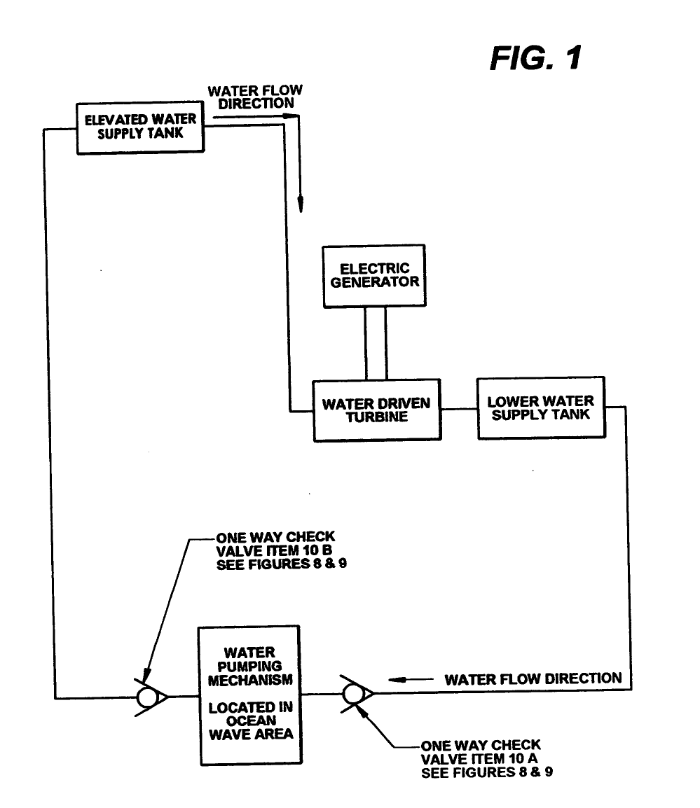

FIG. 1 is a block diagram showing an energy conversion system. A lower water supply tank provides a temporary facility for storing water waiting to be pumped to an elevated water supply tank. A water pumping mechanism located in an ocean wave area and driven by water waves pumps water via pipeline segments from the lower water supply tank, through an inlet line check valve 10A, then through an outlet line check valve 10B and finally to the elevated water supply tank. Inlet line check valve 10A and outlet line check valve 10B are one-way check valves that allow pumping and flow of water only in the indicated water flow direction. While the invention is described for illustrative purposes as pumping water, alternative fluids can be pumped. Similarly, while the invention is described as using water supply tanks, open storage facilities such as ponds or reservoirs could be used.

The elevated water supply tank provides a temporary facility for storage of water (and potential energy) awaiting release to a water-driven turbine. Water is released from the elevated water supply tank and flows via a pipeline segment into the water-driven turbine, which spins in response to the incoming water to drive an electric generator and produce electricity. Water exiting the water-driven turbine returns to the lower water supply tank via another pipeline segment for recycling. The water-driven turbine and the electric generator are preferably land-based to minimize risks of corrosion and malfunction and environmental degradation.

Additional instances of the water pumping mechanism can be added to the energy conversion system within the flow constraints of the water-driven turbine. Naturally, the energy conversion system may also include other components well known to those in the art, such as tank water level control valves and water level make-up and overflow lines with control valves.

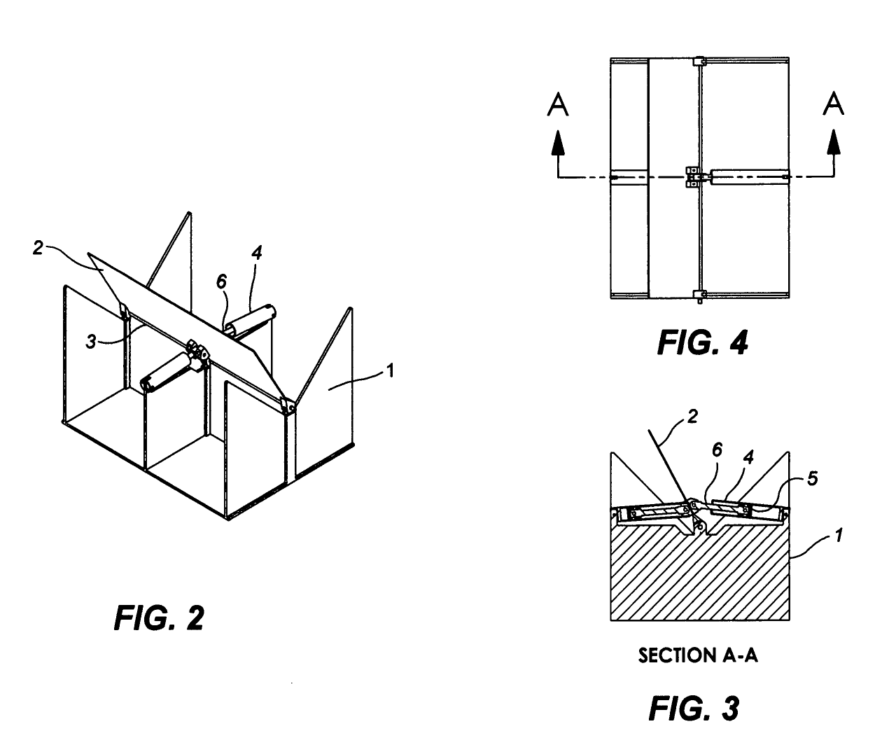

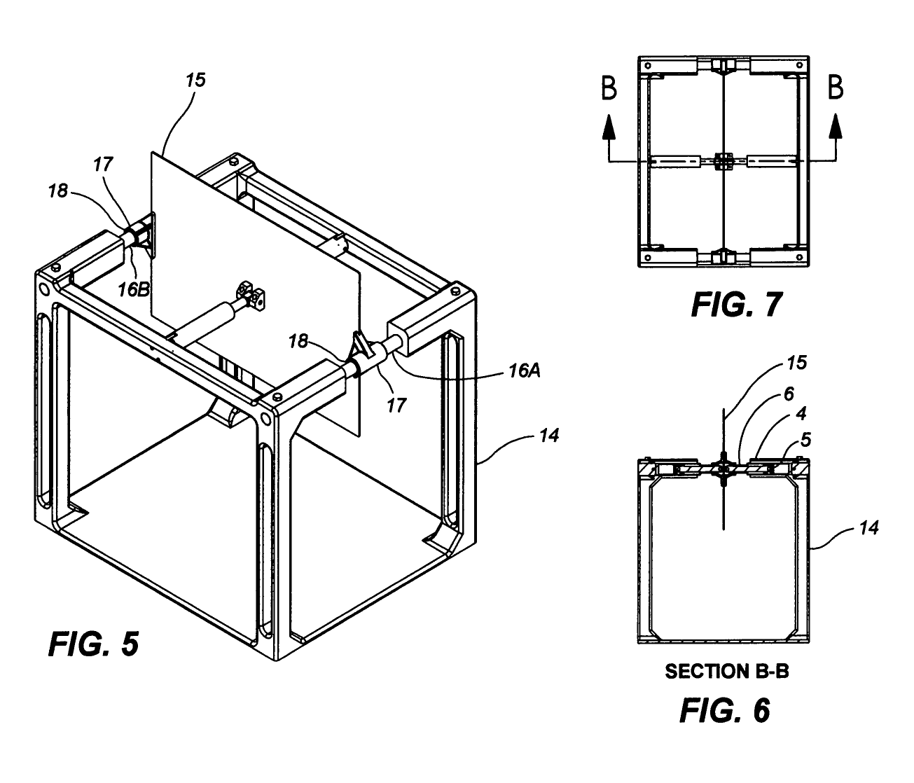

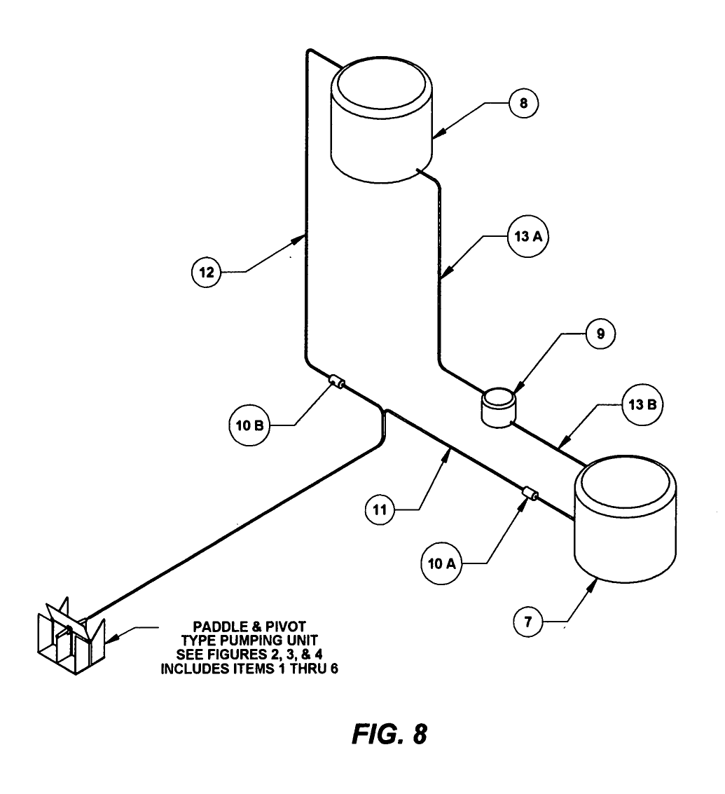

Turning now to FIGS. 2 through 4, a pivot-type pumping unit operative within the water pumping mechanism of FIG. 1 in a preferred embodiment is shown. In operation, the pivot-type pumping unit is submerged in a body of water that experiences reciprocal wave motion, such as an ocean, sea or large lake, and is made of materials resistant to corrosion from water exposure. The pivot-type pumping unit includes a base 1 that supports a paddle 2, a paddle pivot shaft 3, cylinders 4, pistons 5 and paddle-to-piston connecting rods 6. Base 1 is arranged to be stationary within the body of water using conventional mounting. Paddle 2 is rotatably coupled to base 1 and connecting rods 6 using pivots. Cylinders 4 are mounted to base 1 near the ends of cylinders 4 that are remote from paddle 2. Pistons 5 are movably coupled within cavities of cylinders 4 on each side of paddle 2. Connecting rods 6 project from the ends of cylinders 4 that are proximate paddle 2 and link pistons 5 to paddle 2 via pivots. Paddle 2 is a substrate that is preferably positioned with respect to reciprocal water wave motion to provide a large surface area on both sides of paddle 2 for water waves to impinge on, thereby causing paddle 2 to rotate about an axis of rotation defined by shaft 3 within rotational limits defined by base 1. Such rotation causes force to be transmitted through connecting rods 6 to drive pistons 5 inward and outward within cylinders 4. For clarity, “inward” refers to the movement of pistons 5 toward the end of cylinders 4 that is mounted to base 1 and “outward” refers to the movement of pistons 5 in the opposite direction, e.g. toward paddle 2.

Turning now to FIG. 8 in conjunction with FIGS. 2 through 4, an energy conversion system utilizing such a pivot-type pumping unit is shown. As illustrated in FIG. 8, at least one of cylinders 4 has a separate inlet and outlet at the end that is mounted to base 1 for transmitting water between pipeline segments 11, 12 in the water flow direction. In particular, as water wave motion impinges on a first side of paddle 2, one of pistons 5 is driven outward and a volume of water in the pipeline is pulled into the cylinder cavity from pipeline segment 11 through a cylinder inlet. As water wave motion impinges on the second side of paddle 2, the one of pistons 5 is driven inward and the volume of water is pushed out of the cylinder cavity to pipeline segment 12 through a cylinder outlet. This repetitive reciprocal water wave motion eventually elevates the volume of water to elevated water supply tank 8. Inlet line check valve 10A and outlet line check valve 10B ensure that water flows through the at least one of cylinders 4 only in the water flow direction. If desired, both cylinders 4 may be arranged with similar inlets and outlets in order to pump water in the water flow direction in the manner just described.

Water in elevated water supply tank 8 is eventually released via pipeline segment 13A to water-driven turbine 9 and then returns to the lower water supply tank 7 via pipeline segment 13B for recycling.

Turning now to FIGS. 5 through 7, a slider-type pumping unit operative within the water pumping mechanism of FIG. 1 in another preferred embodiment is shown. In operation, the slider-type pumping unit is submerged in a body of water that experiences reciprocal wave motion, such as an ocean, sea or large lake, and is made of materials resistant to corrosion from water exposure. The slider-type pumping unit includes a base 14 that supports a plate 15, sliders 17, slider seals 18, slider shafts 16A, 16B, cylinders 4, pistons 5 and plate-to-piston connecting rods 6. Base 14 is arranged to be stationary within the body of water using conventional mounting. Cylinders 4 are mounted to base 14 near the ends of cylinders 4 that are remote from plate 15. Pistons 5 are movably coupled within the cavities of cylinders 4 on each side of plate 15. Connecting rods 6 project from the ends of cylinders 4 that are proximate plate 15 and link pistons 5 to plate 15 via plate mounts. Plate 15 is a substrate that is preferably positioned with respect to the reciprocal wave motion to provide a large surface area on both sides of plate 15 for water waves to impinge on, thereby moving plate 15 along a sliding axis within longitudinal limits defined by base 14. Such sliding causes force to be transmitted through connecting rods 6 to drive pistons 5 inward and outward within cylinders 4.

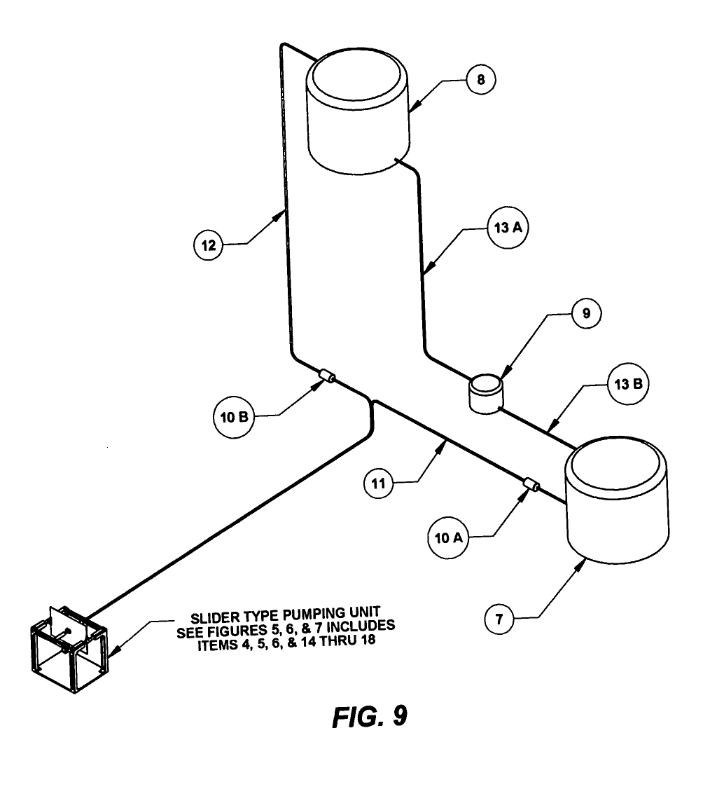

Turning finally to FIG. 9 in conjunction with FIGS. 5 through 7, an energy conversion system utilizing such a slider-type pumping unit is shown. As illustrated in FIG. 9, at least one of cylinders 4 has a separate inlet and outlet at the end that is mounted to base 14 for transmitting water between pipeline segments 11, 12 in the water flow direction. Operation of the energy conversion system proceeds as previously described in relation to FIG. 8, except that water is pumped through the pipeline through impingement of reciprocal wave motion on plate 15, rather than paddle 2.

The various elements of the pivot-type and slider-type pumping units can be sized to provide a desired pumping capacity.

It will be appreciated by those of ordinary skill in the art that the invention can be embodied in other specific forms without departing from the spirit or essential character hereof. For example, as an alternative to having a separate inlet for receiving water and outlet for transmitting water (that is, multiple ports) within cylinders 4, at least one of cylinders 4 could have a single inlet/outlet for receiving/transmitting water (that is, a single port) if combined, for example, with external “T” plumbing circuitry for appropriately directing the water.

The present description is therefore considered in all respects illustrative and not restrictive. The scope of the invention is indicated by the appended claims, and all changes that come within the meaning and range of equivalents thereof are intended to be embraced therein.

1. An energy conversion method, comprising the steps of:
using first energy from water waves to transmit a volume of fluid from a first fluid storage facility to a second fluid storage facility, wherein the second fluid storage facility is positioned at a higher elevation than the first fluid storage facility; and
using second energy from the volume of fluid to generate electricity at an electricity generating facility to which the volume of fluid is transmitted from the second fluid storage facility, wherein the electricity generating facility is positioned at a lower elevation than the second fluid storage facility.

2. The method of claim 1, further comprising the step of transmitting the volume of fluid from the electricity generating facility to the first fluid storage facility for recycling.

3. The method of claim 1, wherein the first energy is captured through interaction of the water waves with a pivot-type pumping unit.

4. The method of claim 1, wherein the first energy is captured through interaction of the water waves with a slider-type pumping unit.

5. The method of claim 1, wherein the second energy is captured through interaction of the volume of fluid with a fluid-driven turbine.

6. The method of claim 1, wherein the electricity generating facility is a fluid-driven turbine/generator unit.

7. The method of claim 1, wherein the electricity generating facility is land-based.

8. The method of claim 1, wherein the fluid is water.

9. A pumping unit for an energy conversion system, comprising:
a base;
a cylinder coupled with the base, wherein a first end of the cylinder has an inlet for receiving a fluid and an outlet for transmitting the fluid;
a piston movably coupled with the cylinder between the first end of the cylinder and a second end of the cylinder;
a connecting rod coupled with the piston, wherein a first end of the connecting rod projects from the second end of the cylinder; and
a wave-receiving substrate coupled with the first end of the connecting rod.

10. The pumping unit of claim 9, wherein the inlet and outlet together comprise multiple ports.

11. The pumping unit of claim 9, wherein the inlet and outlet together comprise a single port.

12. The pumping unit of claim 9, wherein the wave-receiving substrate is a pivoting paddle.

13. The pumping unit of claim 12, wherein the pivoting paddle rotates about a shaft coupled to the base.

14. The pumping unit of claim 9, wherein the wave-receiving substrate is a sliding plate.

15. The pumping unit of claim 14, wherein the sliding plate slides along a shaft coupled to the base.

16. The pumping unit of claim 9, wherein a first water wave impinging on the wave-receiving substrate drives the connecting rod and the piston causing transmission of a volume of the fluid through the inlet.

17. The pumping unit of claim 16, wherein a second water wave impinging on the wave-receiving substrate drives the connecting rod and piston causing transmission of the volume of the fluid through the outlet.

18. The pumping unit of claim 17, wherein the first and second water waves impinge on opposite sides of the wave-receiving substrate.

19. The pumping unit of claim 9, wherein a volume of the fluid is transmitted along a pipeline to a fluid storage facility at a higher elevation than the pumping unit in response to an impingement of a water wave on the wave-receiving substrate.

20. The pumping unit of claim 9, further comprising a cylinder, piston and rod as recited in claim 9 on each side of the wave-receiving substrate.

21. The pumping unit of claim 9, wherein the wave-receiving substrate is coupled to the first end of the connecting rod using a pivot.

22. The pumping unit of claim 9, wherein the wave-receiving substrate is coupled to the first end of the connecting rod using a plate mount.

23. An energy conversion method, comprising the steps of:
receiving a pluralitiy of water waves on a wave-receiving substrate;
driving a piston operatively coupled with the wave-receiving substrate in response to the receiving of the plurality of water waves; and
elevating a volume of fluid through a pipeline operatively coupled with the piston in response to the driving of the piston.

24. The method of claim 23, further comprising the step of releasing the elevated volume of fluid to an electricity generating facility to generate electricity.
